(19) United States
(12) Patent Application Publication
(10) Pub. No.: US 2005/0056729 A1
(43) Pub. Date: Mar. 17, 2005

(54) Particle accelerator space engine

(76) Inventor: John P. Foster, St. Augustine, FL (US)

Correspondence Address: John P. Foster, 395 Dusty Rd., St. Augustine, FL, 32095, US

(21) Appl. No.: 10/657,677

(22) Filed: Sep. 8, 2003

(51) Int. Cl. F02K 1/00

(52) U.S. Cl. 244/172

(57) ABSTRACT

The invention provides two methods of propulsion for vertical and horizontal aerospace flight. Both methods manipulate the mass of a moving particle stream to achieve a desired result. In vertical propulsion, the invention circulates matter, within the confine of a machine, such that a portion of particle speed, which is perpendicular to gravity, is greater than the magnitude of velocity required for circular orbit of the planet, so as to develop radial acceleration relative to the planet center, creating a vertical force, associated with the mass of the particle stream times the radial acceleration, thereby generating vertical thrust. This methodology shall be referred to as “Gyroscopic Lift”. This invention also provides an additional method of horizontal propulsion. In horizontal propulsion, the invention may alternate acceleration and deceleration of matter, as it travels in a circulatory system, so as to create changing centripetal acceleration, and a directional imbalance of forces, thereby developing an outlet to be employed in horizontal thrust. As particles accelerate to the rear during the first ½ cycle an opposite but equal reaction causes forward horizontal propulsion. As particles decelerate in the 2^{nd} ½ cycle, the opposition to slowing down causes forward horizontal propulsion. On port and starboard sides, forces causing particle stream acceleration or deceleration are balanced so as to cancel each others effect. This method of alternating acceleration and deceleration shall be referred to as “Impulse Propulsion”. Although the particular embodiment shown utilizes particles traveling perpendicular to gravity, it should not be concluded that this is the only arrangement possible. Whenever a particle has a component of velocity perpendicular to gravity in excess of circular orbit velocity, it is suitable to provide some measure of vertical thrust. Thus many particle accelerator designs utilizing this feature are feasible for the present invention. As an example, a particle accelerator whose axis of rotation is not aligned with the z axis should provide vertical lift and possibly other precession types of motion for a vehicle. As an alterative embodiment of this invention it provides some measure of gyroscopic lift that may be harnessed. Another example; If the circulatory path of the doughnut is comprised of a shape other than a circle it may increase the potential effect of impulse propulsion, but reduce gyroscopic lift efficiency. A shape comprised of two half circle accelerators, linked into a circulatory pattern by two parallel linear accelerators, would increase the potential horizontal thrust of impulse propulsion. Such is an alternative embodiment of this invention. Thus the invention embraces all space engines which utilize the principles of Gyroscopic Lift, or Impulse Propulsion. Obviously, many modifications and variations of the present invention are possible in the light of the above teachings. It is therefore to be understood that within the scope of the appended claims, the invention may be practiced other than as specifically described.

### CROSS REFERENCE TO RELATED APPLICATIONS

This invention pertains to a propulsion device employing particle accelerator/storage ring/braking device technology to provide novel method and mechanism for vertical propulsion, referred to as “Gyroscopic Lift”. The invention also utilizes particle accelerator/storage ring/braking device in secondary method for horizontal propulsion relative to the ship, referred to as “Impulse Propulsion”.

### FEDERAL STATUS OF FUNDING

The invention described herein is not a Federal funded research and development project.

### BACKGROUND OF INVENTION

The invention builds upon principles found in experimentation by Hideo Hayasaka and Sakae Takeuchi at Tohoku University, Japan, as published in 1989. In this experiment, high speed gyroscopes were allowed to fall between two laser beams inside a vacuum chamber for the purpose of measuring the rate of fall. The conclusion was that the high speed gyroscope fell at a lesser rate of acceleration than gravity. That experiment proved controversial, with problems arising due to small test values of acceleration change, that required extremely high rotational velocities. A solid gyroscope shatters at higher rotational velocity that would provide better testing values. This invention solves that problem by utilizing particle stream technology rather than a solid gyroscope. This invention increases a particles sidestepping velocity to gravity from a minor fraction of circular orbit velocity to a value many times greater than circular orbit velocity. The invention utilizes principle operations of three types of particle stream technology in a new and novel application. Those technologies are particle accelerators, storage rings, and braking devices. In addition, a new mathematical explanation in physics is portrayed to account for the lift provided.

### BRIEF SUMMARY OF THE INVENTION

This invention utilizes particle accelerator/storage ring/braking device technology in a new and novel applications concerning methods of propulsion. The Particle Accelerator Space Engine is mounted about the perimeter of the spacecraft, allowing particle motion to cause reactive motions to the engine, and vice versa. Mathematical trajectories presented here depict how particle motion reacts in planetary celestial mechanics.

### BRIEF DESCRIPTION OF DRAWINGS

FIGS. 1 through 9 are designed to show the methodology and mathematics for vertical propulsion, referred to as “Gyroscopic Lift”. FIG. 1 represents a typical placement for two counter-circulatory particle accelerator doughnuts. The purpose of counter-rotation is to prevent unwanted rotation of the spacecraft. Each doughnut provides thrust as demonstrated in the successive drawings. FIG. 2 represents a circulatory path for particles found in one of the doughnuts, and a directional analysis of velocity vectors for 4 theoretic point particles as related to the earth. The portion of velocity perpendicular to gravity should be noted. FIG. 3 represents a directional analysis of radial acceleration relative to the earth for a typical point particle at an instantaneous moment in time. FIG. 4 represents the particle trajectory for an individual particle as the particle moves through time and space. FIG. 5 represents a directional analysis of radial acceleration as a cumulative effect for the sum of all particles in the circulatory path. FIG. 6 is a pair of two dimensional graphs depicting all accelerative influences exerted upon point particles. FIG. 7 is a mathematical derivation for determining acceleration, and thrust related to vertical propulsion. FIG. 8 is an example of the formula for thrust deerived in FIG. 7. FIG. 9 is a mathematic theoretic example for determining a ships vertical acceleration rate. FIGS. 10 through 12 are a series depicting the methodology and mathematics for horizontal propulsion, referred to as “Impulse Propulsion”. FIG. 10 is a depiction of centripetal acceleration in radial coordinates for alternating accelerative/decelerative ½ cycles. FIG. 11 is a depiction for change in centripetal acceleration in Cartesian coordinates for alternating accelerative/decelerative ½ cycles. FIG. 12 is a particle trajectory for an individual particle as it moves through time and space.

### DETAILED DESCRIPTION

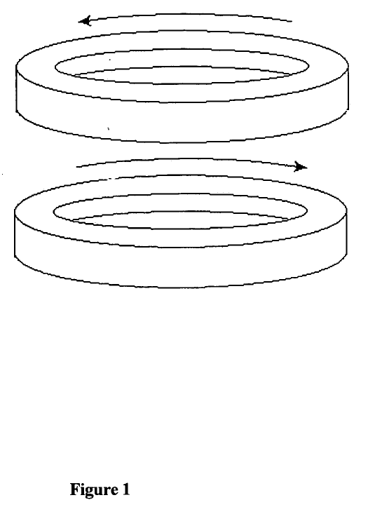

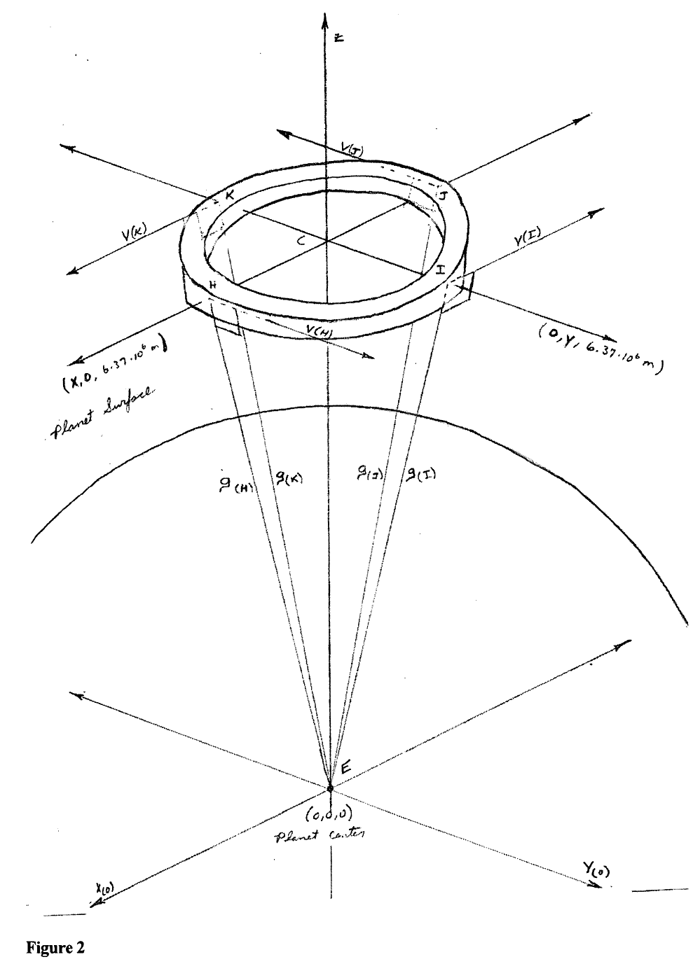

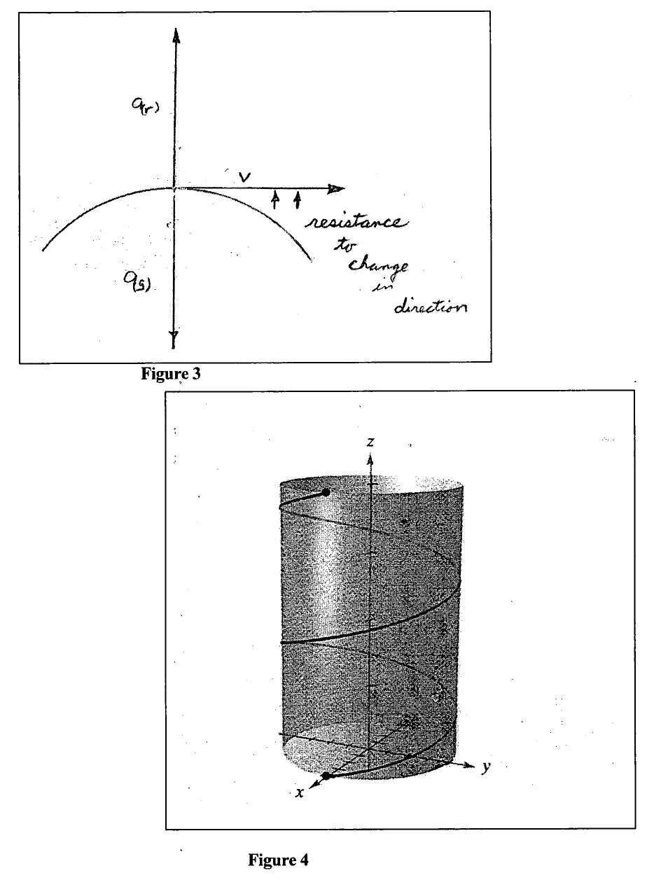

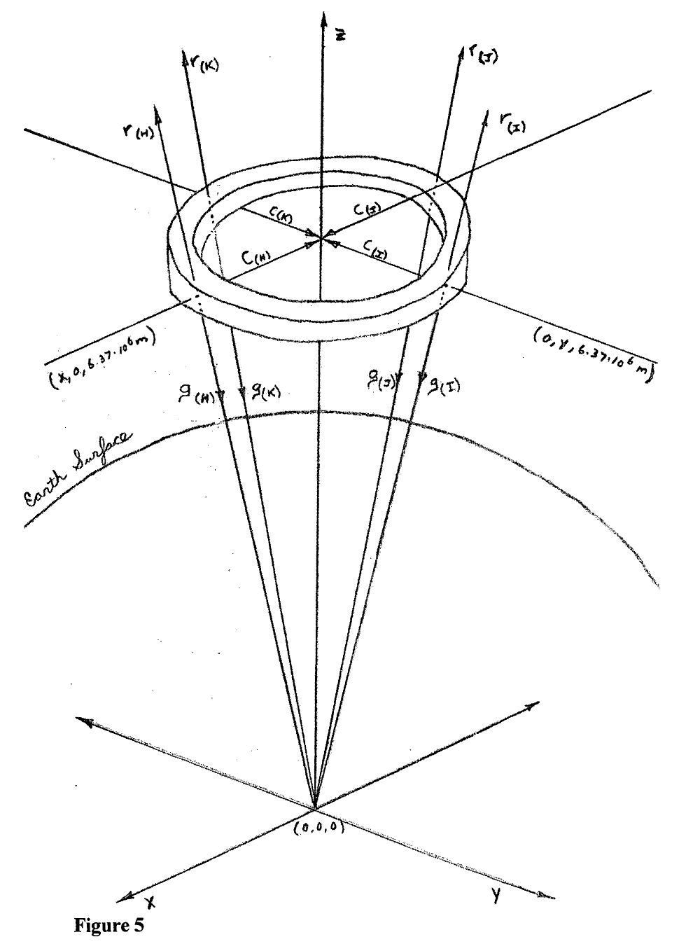

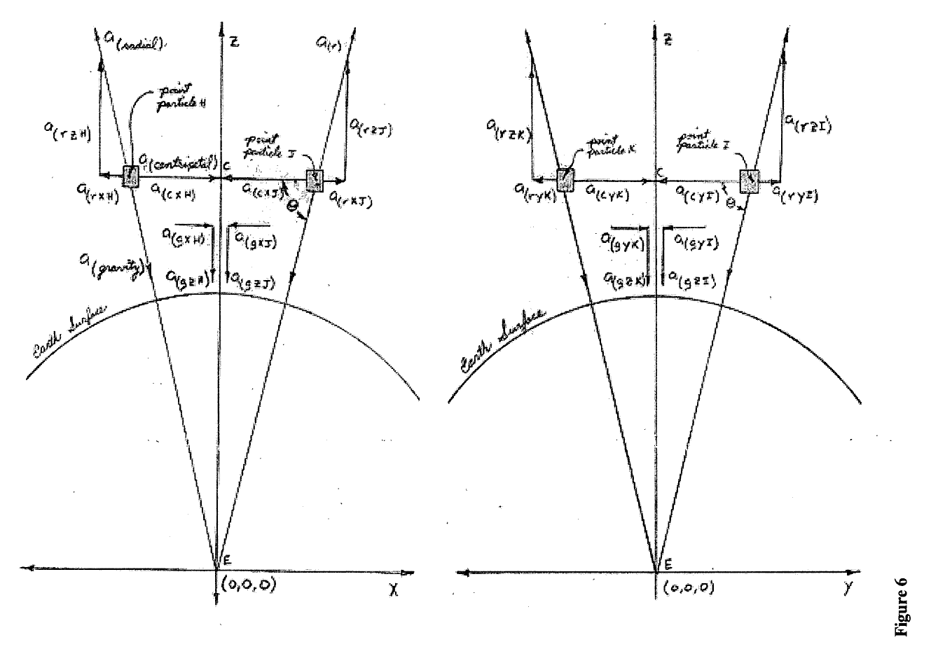

Referring now to the drawings; The Particle Accelerator Space Engine is composed of two circular particle accelerator/storage ring/braking devices, mounted one above the other, with particle streams traveling in counter-rotational directions, as depicted in FIG. 1. The configuration is for the purpose of stabilizing cabin motion, to prevent the cabin from rotating. Both clockwise, and counterclockwise particle accelerators may produce horizontal and/or vertical propulsion. but are capable of providing each other with equal but opposite recoil acceleration. The determination of function at a given time as a particle accelerator, storage ring, or braking device is regulated by particle stream velocity at a given time. The ability to kick a particle to a higher, stable, or lower velocity is regulated by timing and intensity of particle accelerator station kicks, and magnetic forces located about the circumference of the doughnuts. Although these technologies are common practice to the field of particle accelerators, they are not always categorized as such. Mention is made to include the fields of storage rings and braking devices. FIG. 2 is a representation of one of the circular particle accelerators with particles traveling counterclockwise. Particles are circulated in the device at velocities above circular orbit velocity for relative altitude of the planet. For mathematical purposes, symmetry can be used to treat the mass of the particle stream as if it were equally distributed to points that intersect the xz and yz planes, at an instantaneous moment in time. These theoretic point particles are labeled H, I, J and K. FIG. 2 also depicts the directional component of velocity for each point particle perpendicular to gravity. FIG. 3 is a typical representation depicting how the instantaneous component of velocity for a point particle interacts with the earth's gravity to provide radial acceleration relative to the planet. Mathematically, radial acceleration is computed as v²/r, with r representing the radius to the planet center. In all scientific examples, notably those in celestial mechanics, objects that travel perpendicular to gravity above circular orbit velocity continue on, to gain altitude as time progresses. In such state, the particle may be regarded as sidestepping gravity, at a faster rate than falling. Most of celestial mechanics involves two dimensional curved trajectories. Typically, an object that has velocity perpendicular to gravity between circular orbit velocity and escape velocity enters the ascending side of an elliptic orbit. At escape velocity, an object enters the ascending side of a parabolic obit, and above escape velocity an object enters the ascending side of a hyperbolic orbit. Unless other perturbing forces are present, to throw the object off track, it always gains altitude. In the Particle Accelerator Space Engine, the magnitude of velocity for the particle stream is much greater than escape velocity. The effect of an ascending hyperbolic orbit with a centripetal perturbation towards the center axis of rotation in the Particle Accelerator Space Engine creates an ascending helical trajectory. FIG. 4 depicts an ascending helical trajectory for an individual particle as it moves through 3 dimensional space. The upward spiral of the point particle is contained by electromagnetic forces within the Particle Accelerator Space Engine. The forces exerted by the particle stream, onto the engine, create lift for the craft. FIG. 5 is a 3 dimensional depiction for all theoretic point particles, and the instantaneous acceleration vectors of gravity, centripetal acceleration relative to the center of the accelerator, and radial acceleration relative to the planet. FIG. 6 is a pair of two dimensional graphs representing the xz, and yz planes. The acceleration vectors in FIG. 5 are transcribed to FIG. 6, such that component values can be easily seen. The trigonomic triangles enable the vectors to be broken down to component vectors for their respective axis. Point particle H is traveling perpendicular to the page outward. Point particle J is traveling perpendicular to the page inward. Point particle K is traveling perpendicular to the page outward. Point particle I is traveling perpendicular to the page inward. Sample initialing:
a_{(rxH)}=radial acceleration component, to earth center relative to x axis for particle H.
a_{(rzH)}=radial acceleration component, to earth center relative to z axis for particle H.
a_{(cxH)}=centripetal acceleration component, to ring center relative to x axis for particle H.
a_{(czH)}=centripetal acceleration component, to ring center relative to z axis for particle H
a_{(gxH)}=gravity acceleration component, to earth center relative to x axis for particle H.
a_{(gzH)}=gravity acceleration component, to earth center relative to z axis for particle H.
a_{(rxJ)}=radial acceleration component, to earth center relative to x axis for particle J.
a_{(rzJ)}=radial acceleration component, to earth center relative to z axis for particle J.
a_{(cxJ)}=centripetal acceleration component, to ring center relative to x axis for particle J.
a_{(czJ)}=centripetal acceleration component, to ring center relative to z axis for particle J
a_{(gxJ)}=gravity acceleration component, to earth center relative to x axis for particle J.
a_{(gzJ)}=gravity acceleration component, to earth center relative to z axis for particle J.
a_{(ryK)}=radial acceleration component, to earth center relative to y axis for particle K.
a_{(rzK)}=radial acceleration component, to earth center relative to z axis for particle K.
a_{(cyK)}=centripetal acceleration component, to ring center relative to y axis for particle K.
a_{(czK)}=centripetal acceleration component, to ring center relative to z axis for particle K
a_{(gyK)}=gravity acceleration component, to earth center relative to y axis for particle K.
a_{(gzK)}=gravity acceleration component, to earth center relative to z axis for particle K.
a_{(ryI)}=radial acceleration component, to earth center relative to y axis for particle I.
a_{(rzI)}=radial acceleration component, to earth center relative to z axis for particle I.
a_{(cyI)}=centripetal acceleration component, to ring center relative to y axis for particle I.
a_{(czI)}=centripetal acceleration component, to ring center relative to z axis for particle I
a_{(gyI)}=gravity acceleration component, to earth center relative to y axis for particle I.
a_{(gzI)}=gravity acceleration component, to earth center relative to z axis for particle I.

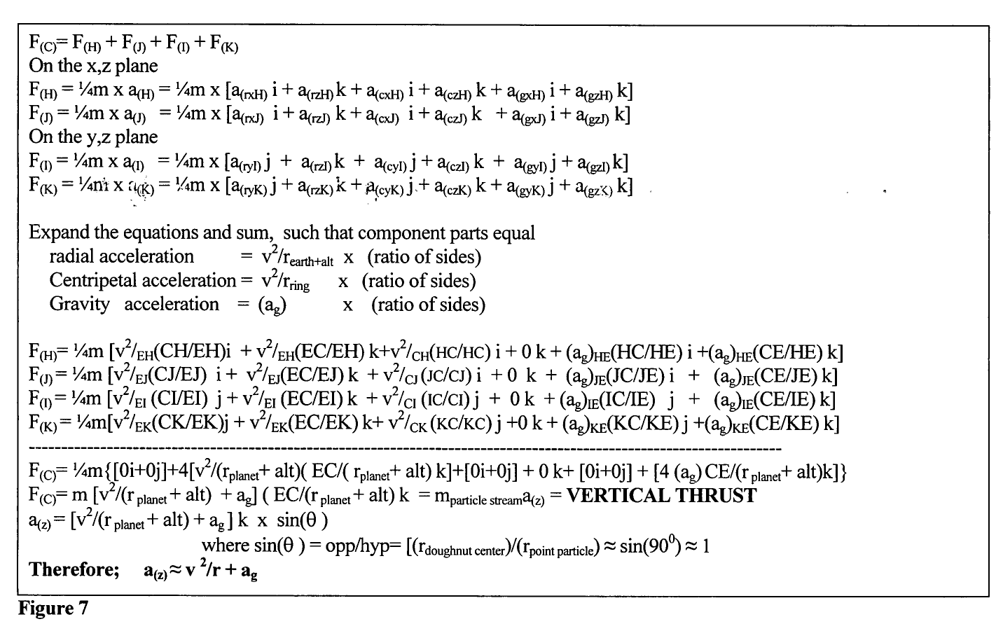

FIG. 7 is a mathematical formula for determining gyroscopic lift. It sums the component vectors of acceleration in a manner that reveals an equation for instantaneous thrust, and instantaneous acceleration in the z direction. To describe the mathematical process: An initial equation is generated for Force exerted by each of the 4 theoretic point particles. Each particle is assigned ¼ of the mass of the particle stream which is multiplied by the cumulative accelerations exerted on or by the particle. The four point particle equations are written one above another so as to form columns for summation. Although the hypotenuse' for the 4 theoretic point particles may differ in direction, their magnitudes are equal, and their component vectors either compliment one another or oppose one another. When all of the acceleration vectors are broken down into vector components then summed, the result causes many vector components to cancel each other out, leaving only acceleration in the z direction, referred to as a_{(z)}. The mathematical formula for vertical acceleration is: a_{(z)}≈v²/r+a_{g}. The mathematical formula for vertical thrust is: m_{particle stream}a_{(z)}=thrust.

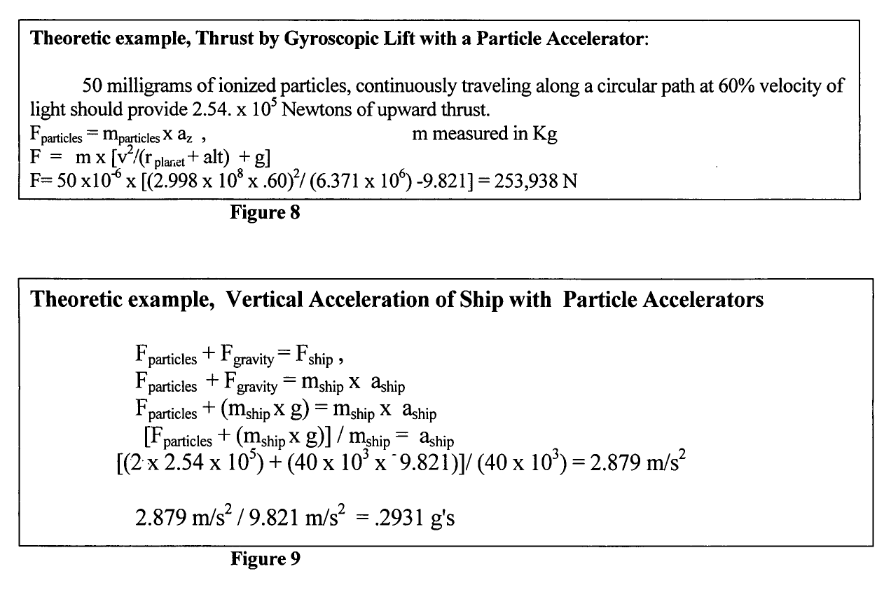

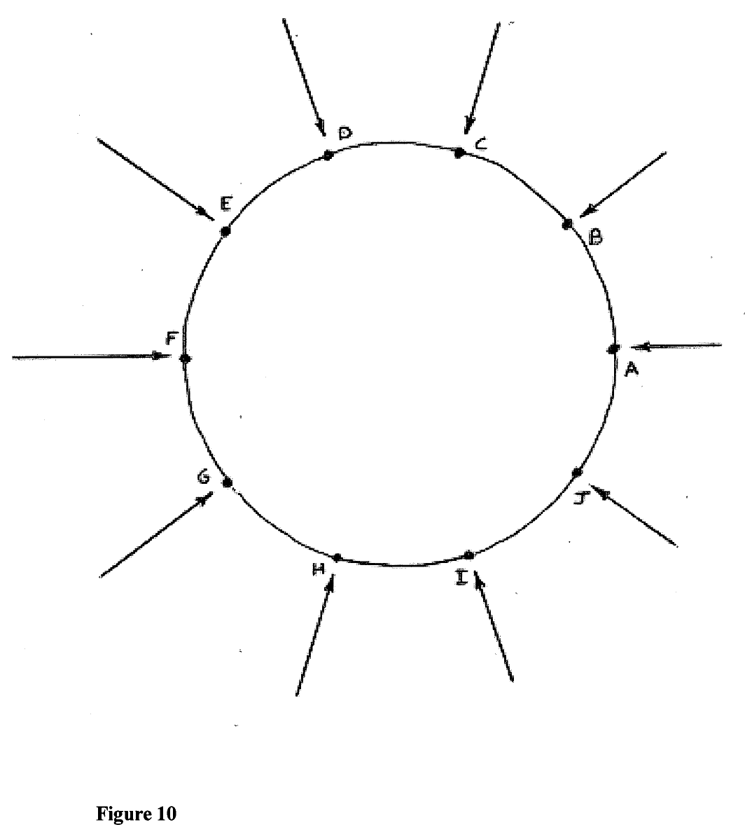

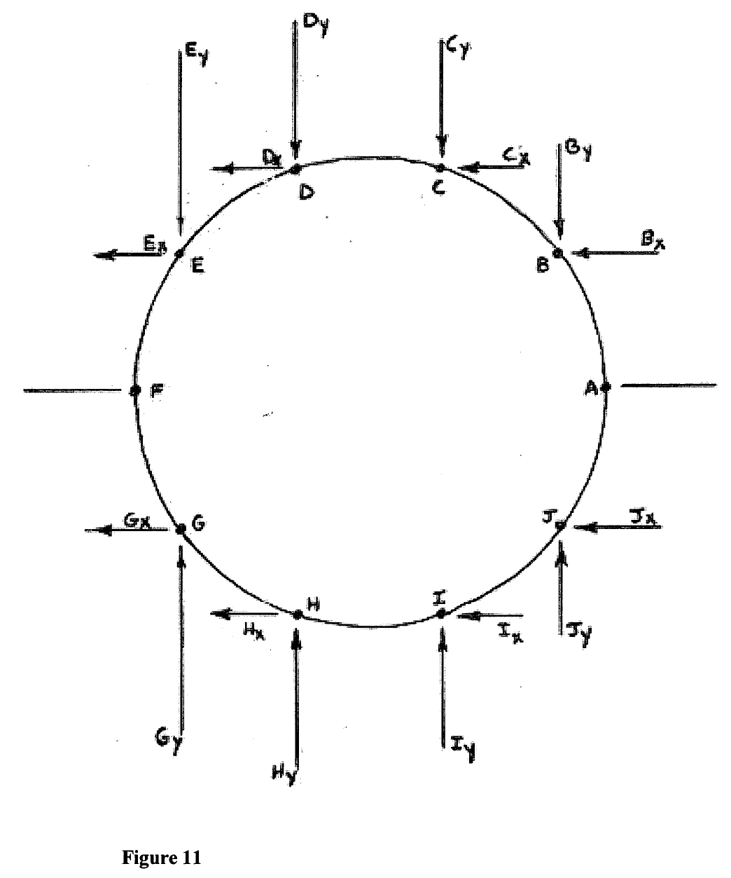

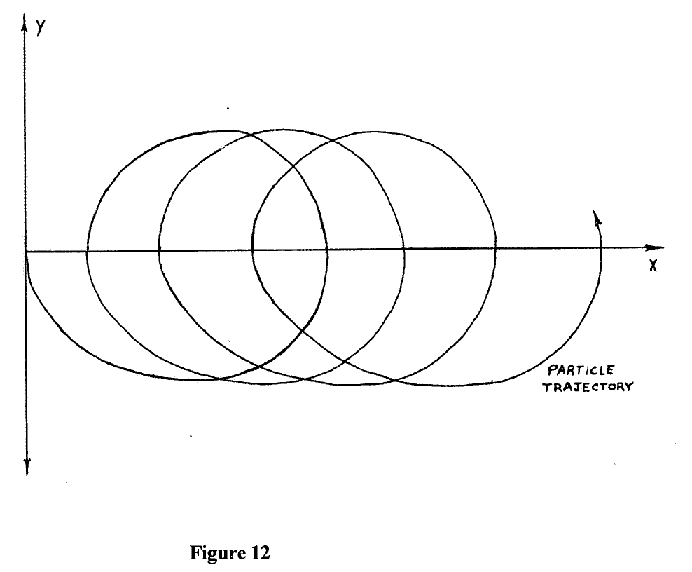

FIG. 8 is a mathematical model presented for the purpose of demonstrating use of the equations for vertical thrust. In the upper equation an amount of thrust is calculated for 50 milligrams of ionized particles traveling at 60% velocity of light in one of the particle accelerator rings. The particle stream may be brought to a constant velocity, similar to a storage ring, but with the intent of harnessing upward thrust. For an individual ring, this example produces 2.54×10⁵ Newtons of thrust. Although specific values are used for mass, velocity, and thrust, the equations are not limited to these values, nor is it required that the velocity of the particle stream be constant, in order that upward thrust be developed. Many combinations of particle stream velocity, and mass are possible, such that varying these configurations while in flight allows the craft to navigate altitude. FIG. 9 is a mathematical model for the purpose of demonstrating use of equations derived in FIG. 8. If the vehicle is fitted with two particle accelerators, with particle flow in counter-rotational directions, it would double the upward thrust. This should enable 40 metric tons to be lifted upward at an acceleration rate of 2.9 m/s². The equation adds upward force, that is generated through gyroscopic lift of the particles, with downward force of gravity as applied to the deadweight of the ship, to determine the overall force with which the craft should move. With particle velocity of 0.6 c, a vehicle, such as a commercial passenger vehicle, fitted with a circular Particle Accelerator Space Engine around the perimeter, and deadweight of approximately 40 metric tons would be capable of vertical acceleration at about 0.3 g's. In the vacuum of outer space it has the potential to develop a very high top velocity. Once a desired altitude is found, it may be stabilized by adjusting the particle stream velocity such that upward thrust that is generated matches the the force of gravity. Any velocity of circulatory matter exceeding circular orbit velocity may be utilized to harness upward acceleration and/or thrust. Thus many combinations of matter quantity, and velocity may be combined to create and/or navigate using such a propulsion engine.

FIGS. 10 through 12 are a series depicting the methodology for horizontal propulsion, referred to as “Impulse Propulsion”. FIG. 10 is a depiction of the centripetal acceleration pattern for a particle that accelerates during a half cycle, and decelerates during the other half cycle. Particles, beginning at point A, must increase centripetal acceleration when passing through each successive point to keep on a circular path, until reaching point F. At point F particles start a decelerative ½ cycle. Each successive point requires less centripetal acceleration to maintain the circular path. Equal particle speeds are located at B&J, C&I, D&H, E&G

FIG. 11 is a depiction of change in acceleration in Cartesian Coordinates. The change in acceleration is both a change per time, and a change per angle. It must be computed individually for each point about the circumference of the particle stream. In Cartesian coordinates, y components cancel, when summed, and a directional component may be found to cause motion along the x axis. Y components, for change in acceleration, during the accelerative ½ cycle, have symmetric, equal but opposite, counterparts in the decelerative ½ cycle. As such, particles at B_{y} provide equal but opposite force along the y axis to particles at J_{y}. Particles at C_{y} provide equal but opposite force along the y axis to particles at I_{y}. Particles at D_{y} provide equal but opposite force along the y axis to particles at H_{y}. Particles at E_{y} provide equal but opposite force along the y axis to particles at G_{y}. This symmetric relation eliminates recoil acceleration of the ship in the positive or negative y direction.

When the y component of acceleration is eliminated it leaves only the x component of particle acceleration. As particles are accelerated through stations in one direction, the accelerator station and ship are accelerated in the opposite direction. During the first ½ cycle, particles are accelerated in the negative x direction. The hull of the ship responds by accelerating in the positive x direction. During the remaining decelerative ½ cycle, a series of repulsive forces are placed downstream. Change in particle acceleration is again measured in the negative x direction. Particles approaching the repulsive force push the ship in the positive x direction. At points A and F, particles are neither accelerating nor decelerating. The zero net change in acceleration at those points keeps circular motion but does not add to impulse propulsion. The remaining accelerative and decelerative ½ cycles have a common direction of accelerative influence for the space engine in the positive x direction.

A symmetry analysis also reveals that if two counter-rotational particle accelerators/storage rings/braking device are placed one above another, with low and high velocities found at common points on the top view circle, then equal velocities should be found at equal points throughout the both circles. This symmetry aids the mathematical determination of timing particle kicks on lower and upper accelerator doughnuts. A note need also be made that the positioning of low point velocity, and high point velocity of the particle stream need not necessarily be isolated to the intersection of the x axis. Other pairs of points may be utilized along the perimeter, that have a 180° relationship to each other, as high and low points of the ½ cycle relationship. This characteristic allows horizontal propulsion in any direction of the 360° located in the horizontal plane. In such manner, the Particle Accelerator Space Engine may also veer left, right or slow down along the plane of the horizon

FIG. 12 is a depiction of a particle trajectory, for an individual particle, as the vehicle and Particle Accelerator Space Engine moves through space, and time. Let us say that a circular accelerator is the means of propulsion for a space craft. From the viewpoint of a passenger, the particle flow is along a stationary path around them. To a person on the ground the particle path follows a scribble pattern as the accelerator moves in a forward direction.

1.) The invention creates a new method and mechanism of vertical propulsion. It circulates matter, within the confine of a machine, at velocities above that required for circular orbit of the planet, for the purpose of utilizing whatever portion of particle radial acceleration, relative to the planet center, that can be harnessed toward creating vertical propulsion for the entire machine.

2.) The invention creates a new secondary method and mechanism of propulsion, which is to alternate the acceleration and deceleration of circulatory matter in such manner as to establish a directional component that may be applied to acceleration in a horizontal direction relative to the ship.
